(19) United States
(12) Patent Application Publication
(10) Pub. No.: US 2009/0092434 A1
(43) Pub. Date: Apr. 9, 2009

(54) PRINT MEDIA MOVING APPARATUS

(76) Inventor: Tsung-Yueh Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/020,580

(22) Filed: Jan. 28, 2008

(30) Foreign Application Priority Data
Oct. 8, 2007 (TW) 096137703

(51) Int. Cl. B41J 13/03

(52) U.S. Cl. 400/636

(57) ABSTRACT

A print media moving apparatus is disposed in a printer for controlling movement of a print media. The print media moving apparatus includes a motor, a first media moving module, a second media moving module, a controlling module, a first power transmission module and a second power transmission module. The first and second media moving module are both coupled to the motor. The controlling module is coupled to the first and second media moving modules, and is for turning on the first media moving module when the printer operates under a first mode, and turning on the second media moving module when the printer operates under a second mode. The first and second power transmission modules are respectively coupled between the motor and the first and second media moving modules, and are respectively for delivering power from the motor to the first and second media moving modules.

### BACKGROUND OF THE INVENTION

1. Field of the Invention

The present invention relates to a print media moving apparatus, and more particularly, to a print media moving apparatus disposed in a printer, having a first media moving module, a second media moving module and a controlling module. The controlling module selectively turns on the first media moving module or the second media moving module for controlling movement of a print media.

2. Description of the Prior Art

In general, color printers can be classified into four major types: dot matrix printers, inkjet printers, laser printers and dye diffusion thermal printers. The dye diffusion thermal printer utilizes a thermal print head to heat ribbons containing dyes in order to transfer the dyes onto an object to be printed. In this way, continuous-tone can be formed on the object according to the heating time or the heating temperature. Due to its excellent printing quality and the natural, continuous color expression, the thermal printer is particularly suitable for photo printing applications.

In general, the dye diffusion thermal printer is capable of operating under a printing mode or a paper-moving mode since the dyes in respective ribbons with respective colors are transferred onto the object to be printed (e.g., paper). While operating under the printing mode, the dye diffusion thermal printer motor moves the object from an initial position to transfer dye of one specific color on the ribbon onto the object. Next, the dye diffusion thermal printer is switched to operate under the paper-moving mode. Under the paper-moving mode, the motor moves the object back to the initial position so as to transfer the dye of another specific color on the ribbon onto the object.

Please refer to FIG. 1. FIG. 1 is a diagram illustrating a typical dye diffusion thermal printer 100. As shown in FIG. 1, the dye diffusion thermal printer 100 comprises a stepping motor 110, an active pulley 122, a belt 124, a passive pulley 126, a capstan roller 132 and a pinch roller 134. The active pulley 122 is coupled to the stepping motor 110, the passive pulley 126 is coupled to the capstan roller 132, and the active pulley 122 and passive pulley 126 are coupled to each other via the belt 124. The power generated from the stepping motor 110 is therefore delivered to the capstan roller 132 through the active pulley 122, the belt 124 and the passive pulley 126 in sequence for rotating the capstan roller 132. Both the capstan roller 132 and the pinch roller 134 are in contact with a print media 10 (e.g., a piece of paper or a card). When the capstan roller 132 rotates, the pinch roller 134 is driven to rotate simultaneously to move the print media 10 together. The moving direction of the print media 10 depends on the rotating direction of the capstan roller 132. Taking FIG. 1 for example, when the capstan roller 132 rotates counterclockwise, the print media 10 is moved to the right (printing/paper-moving mode); otherwise, when the capstan roller 132 rotates clockwise, the print media 10 is moved to the left (paper-moving/printing mode).

To ensure a good print quality, the motor operating under the printing mode is expected to output with a high torque, and the motor operating under the paper-moving mode is expected to output at high speed. There is a fundamental trade-off, however, between torque and speed while the driving voltage is on the fixed level. More specifically, the motor can either output with a high torque but low speed or output with a high speed but low torque. As mentioned above, the prior art only uses one stepping motor to drive the capstan roller for rotating. With the traditional method, in order to make the stepping motor output with a high torque and high speed, high voltage or high current is required to drive the stepping motor. This method consumes high power, however. In addition, the volume of the stepping motor is also increased for the purpose of providing high speed and high torque. Furthermore, the temperature of the motor will get extremely high since the motor operates at the high power mode continuously.

### SUMMARY OF THE INVENTION

It is therefore one of the objectives of the present invention to provide a print media moving apparatus having two media moving modules and two power transmission modules. The print media moving apparatus turns on the different print media moving apparatuses according to the different operating modes and turns on a corresponding power transmission module so as to control movement of a print media.

According to an exemplary embodiment of the present invention, a print media moving apparatus is disposed in a printer for controlling movement of a print media. The print media moving apparatus comprises: a motor, a first media moving module, a second media moving module, a controlling module, a first power transmission module and a second power transmission module. The first power transmission module is coupled between the motor and the first media moving module for delivering power from the motor to the first media moving module. The second power transmission module is coupled between the motor and the second media moving module for delivering power from the motor to the second media moving module. The controlling module is coupled to the first media moving module and the second media moving module for turning on the first media moving module to move the print media when the printer operates under a first mode, and turning on the second media moving module to move the print media when the printer operates under a second mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a typical dye diffusion thermal printer.

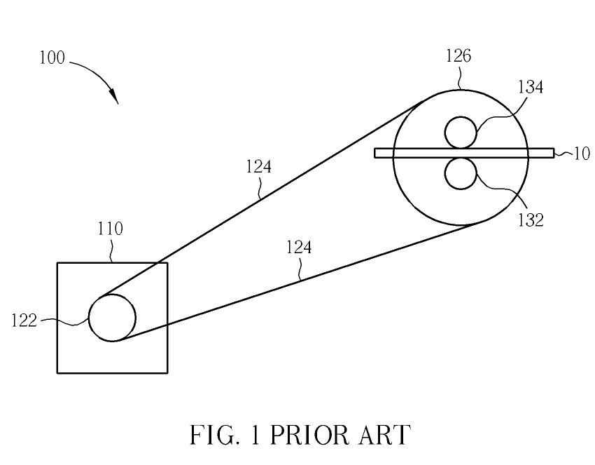

FIG. 2 is a simplified diagram illustrating a print media moving apparatus according to an embodiment of the present invention.

FIG. 3 is a diagram illustrating the print media moving apparatus operating under a first mode.

FIG. 4 is a diagram illustrating the print media moving apparatus operating under a second mode.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

Different features of the present invention are detailed as below with reference to the figures, and for convenience of explanation, the same elements in different figures have the same reference numerals.

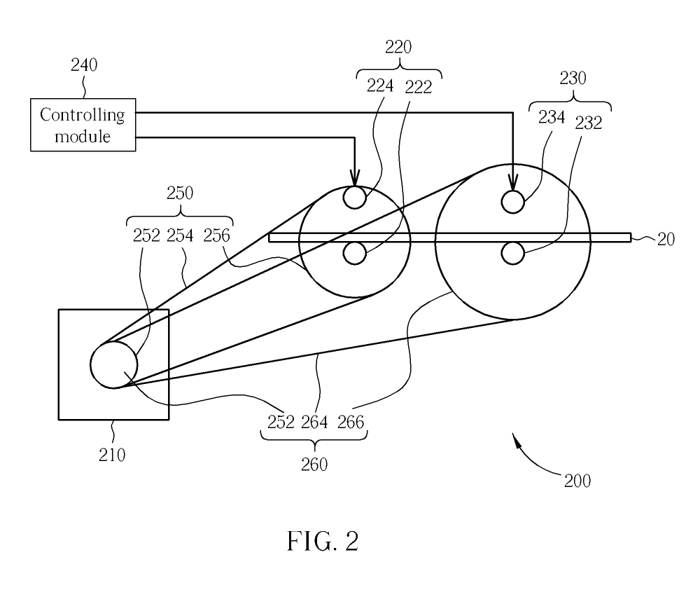

Please refer to FIG. 2. FIG. 2 is a simplified diagram illustrating a print media moving apparatus 200 according to an embodiment of the present invention. The print media moving apparatus 200 is disposed in a printer for controlling movement of a print media 20. As shown in FIG. 2, the print media moving apparatus 200 comprises a motor 210, a first media moving module 220, a second media moving module 230, a controlling module 240, a first power transmission module 250 and a second power transmission module 260. Both the first media moving module 220 and the second media moving module 230 are coupled to the motor 210. The first power transmission module 250 is coupled between the motor 210 and the first media moving module 220 for delivering power from the motor 210 to the first media moving module 220. The second power transmission module 260 is coupled between the motor 210 and the second media moving module 230 for delivering power from the motor 210 to the second media moving module 230. The controlling module 240 is coupled to the first and second media moving modules 220, 230 for turning on the first media moving module 220 to move the print media 20 when the printer operates under a first mode, and turning on the second media moving module 230 to move the print media 20 when the printer operates under a second mode.

The first media moving module 220 comprises a first capstan roller 222 and a first pinch roller 224. The second media moving module 230 comprises a second capstan roller 232 and a second pinch roller 234. The first power transmission module 250 comprises an active pulley 252, a first belt 254 and a first passive pulley 256. The second power transmission module 260 comprises the active pulley 252, a second belt 264 and a second passive pulley 266. This means the first and second power transmission modules 250, 260 share the active pulley 252. In the first power transmission module 250, the active pulley 252 is coupled to the motor 210 for receiving power from the motor 210; the first passive pulley 256 is coupled to the first capstan roller 222; and the first belt 254 is coupled between the active pulley 252 and the first passive pulley 256 for delivering power from the active pulley 252 to the first passive pulley 256. Similarly, in the second power transmission module 260, the active pulley 252 is coupled to the motor 210 for receiving power from the motor 210; the second passive pulley 266 is coupled to the second capstan roller 232; and the second belt 264 is coupled between the active pulley 252 and the second passive pulley 266 for delivering power from the active pulley 252 to the second passive pulley 266. A first radius ratio for the active pulley 252 and the first passive pulley 256 is different from a second radius ratio for the active pulley 252 and the second passive pulley 266. In other words, the reduction ratio for the first power transmission module 250 is different from the reduction ratio for the second power transmission module 260. In addition, in this embodiment, the print media moving apparatus 200 is disposed in a dye diffusion thermal transfer printer, and the motor 210 is a stepping motor. The further operations of the print media moving apparatus 200 will be explained in the following. To make the concept of the present invention easily appreciable, a card taken as the print media 20 is utilized in the following embodiment; this is, however, for illustrative purposes and not a limitation of the prevent invention.

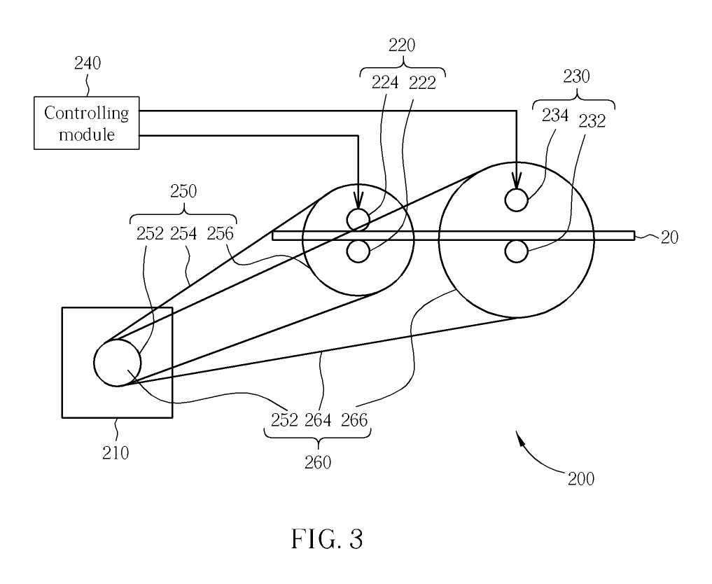

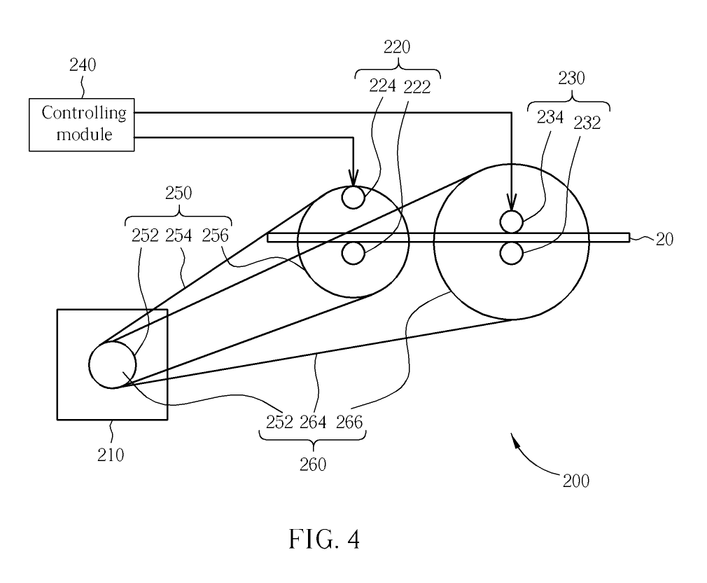

Please refer to FIG. 3, FIG. 4 and FIG. 2 together. FIG. 3 is a diagram illustrating the print media moving apparatus 200 operating under a first mode, and FIG. 4 is a diagram illustrating the print media moving apparatus 200 operating under a second mode. When the printer operates under neither the first mode nor the second mode, neither the first pinch roller 224 of the first media moving module 220 nor the second pinch roller 234 of the second media moving module 230 will be in contact with the print media 20 as shown in FIG. 2. When the printer operates under the first mode, the controlling module 240 controls the first pinch roller 224 of the first media moving module 220 to move downward so as to make both the first capstan roller 222 and the first pinch roller 224 come into contact with the two sides of the print media 20 respectively. In addition, the second pinch roller 234 of the second media moving module 230 is not in contact with the print media 20. In this way, the first pinch roller 224 is able to rotate with the rotation of the first capstan roller 222 to move the print media 20. When the printer operates under the second mode, the controlling module 240 controls the second pinch roller 234 of the second media moving module 230 to move downward so as to make both the second capstan roller 232 and the second pinch roller 234 come into contact with the two sides of the print media 20 respectively. In addition, the first pinch roller 224 of the first media moving module 220 is not in contact with the print media 20. In this way, the second pinch roller 234 is able to rotate with the rotation of the second capstan roller 232 to move the print media 20.

The first radius ratio for the active pulley 252 and the first passive pulley 256 in the first power transmission module 250 is greater than the second radius ratio for the active pulley 252 and the second passive pulley 266 in the second power transmission module 260. As can be seen in FIG. 2, the radius of the first passive pulley 256 is less than the radius of the second passive pulley 266. While the motor 210 outputs with a fixed speed and torque, the speed of the first capstan roller 222 coupled to the first passive pulley 256 is higher than the speed of the second capstan roller 232 coupled to the second passive pulley 266, and the torque outputted from the second capstan roller 232 is greater than the torque outputted from the first capstan roller 222. Thus, the first capstan roller 222 outputs at a high speed when the printer operates under the first mode, and the second capstan roller 232 outputs with a high torque when the printer operates under the second mode. In addition, in this embodiment, the first mode is a paper-moving mode, and the second mode is a printing mode. Despite being driven by the same motor, a high speed output under the paper-moving mode and a high torque output under the printing mode can be expected only if the first radius ratio and the second radius ratio are designed properly. In this way, both good print quality and high print efficiency can be ensured. Moreover, since the first radius ratio is specially designed for the print mode, and the second radius ratio is specially designed for the paper-moving mode, the high-frequency noise due to the motor 210 rotating at a high speed can be avoided.

Please note that, although the first power transmission module 250 and the second power transmission module 260 share the active pulley 252 in this embodiment, this is for illustrative purposes only and is not deemed to be a limitation of the present invention. For example, the first power transmission module 250 and the second power transmission module 260 can both respectively comprise an active pulley, which is coupled to the motor 210. After reading the above-mentioned description, a corresponding operation of the print media moving apparatus whose first and second power transmission modules respectively comprise an active pulley should be readily appreciated by those skilled in the art, so further description is omitted here for the sake of brevity.

Please note that both the first and second power transmission modules 250 and 260 are implemented by an active pulley, a belt and a passive pulley; this is, however, merely for illustrative purposes and is not deemed to be a limitation of the present invention. In other embodiments, the power transmission module can be implemented by a gear set depending on design requirements. Those skilled in the art should readily appreciate how to implement the power transmission module by a gear set, so further description is omitted here for the sake of brevity. Furthermore, that the first and second moving modules 220, 230 are implemented by a capstan roller and a pinch roller is only for illustrative purposes, and is not a limitation of the prevent invention. Using any alternative mechanisms to achieve the objective of moving the print media 20 also falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A print media moving apparatus, disposed in a printer, for controlling movement of a print media, the print media moving apparatus comprising:
a motor;
a first media moving module, coupled to the motor;
a second media moving module, coupled to the motor;
a controlling module, coupled to the first media moving module and the second media moving module, for turning on the first media moving module to move the print media when the printer operates under a first mode, and turning on the second media moving module to move the print media when the printer operates under a second mode;
a first power transmission module, coupled between the motor and the first media moving module, for delivering power from the motor to the first media moving module; and
a second power transmission module, coupled between the motor and the second media moving modules, for delivering power from the motor to the second media moving module.

2. The print media moving apparatus of claim 1, wherein the first media moving module comprises:
a first capstan roller; and
a first pinch roller; and
the second media moving module comprises:
a second capstan roller; and
a second pinch roller;
wherein when the printer operates in the first mode, the controlling module controls both the first capstan roller and the first pinch roller to come into contact with the print media to move the print media; and when the printer operates in the second mode, the controlling module controls both the second capstan roller and the second pinch roller to come into contact with the print media to move the print media.

3. The print media moving apparatus of claim 2, wherein the first power transmission module comprises:
a first active pulley, coupled to the motor, for receiving power from the motor;
a first passive pulley, coupled to the first capstan roller; and
a first belt, connected between the first active pulley and the first passive pulley, for delivering power from the first active pulley to the first passive pulley; and
the second power transmission comprises:
a second active pulley, coupled to the motor, for receiving power from the motor;
a second passive pulley, coupled to the second capstan roller; and
a second belt, connected between the second active pulley and the second passive pulley, for delivering power from the second active pulley to the second passive pulley;
wherein a first radius ratio for the first active pulley and the first passive pulley is different from a second radius ratio for the second active pulley and the second passive pulley.

4. The print media moving apparatus of claim 3, wherein the first mode is a paper-moving mode, the second mode is a printing mode, and the first radius ratio is greater than the second radius ratio.

5. The print media moving apparatus of claim 2, wherein the first power transmission module comprises:
an active pulley, coupled to the motor, for receiving power from the motor;
a first passive pulley, coupled to the first capstan roller; and
a first belt, connected between the active pulley and the first passive pulley, for delivering power from the active pulley to the first passive pulley; and
the second power transmission comprises:
the active pulley;
a second passive pulley, coupled to the second capstan roller; and
a second belt, connected between the active pulley and the second passive pulley, for delivering power from the active pulley to the second passive pulley;
wherein a first radius ratio for the active pulley and the first passive pulley is different from a second radius ratio for the active pulley and the second passive pulley.

6. The print media moving apparatus of claim 5, wherein the first mode is a paper-moving mode, the second mode is a printing mode, and the first radius ratio is greater than the second radius ratio.

7. The print media moving apparatus of claim 2, wherein the first power transmission module drives the first capstan roller to rotate at a first speed, the second power transmission module drives the second capstan roller to rotate at a second speed, and the first speed is different from the second speed.

8. The print media moving apparatus of claim 7, wherein the first mode is a paper-moving mode, the second mode is a printing mode, and the first speed is greater than the second speed.

9. The print media moving apparatus of claim 1, wherein the printer is a dye diffusion thermal transfer printer.

10. The print media moving apparatus of claim 1, wherein the motor is a stepping motor.
